(19) United States
(12) Patent Application Publication
(10) Pub. No.: US 2014/0285415 A1
(43) Pub. Date: Sep. 25, 2014

(54) CONTROL SIGNAL GENERATING DEVICE AND AUDIO SIGNAL PROCESSING DEVICE

(71) Applicant: Yamaha Corporation, Hamamatsu-shi (JP)

(72) Inventors: Koji ASADA, Hamamatsu-shi (JP); Masahiro Sasagawa, Hamamatsu-shi (JP); Yoshihiro Suzuki, Hamamatsu-shi (JP)

(73) Assignee: Yamaha Corporation, Hamamatsu-shi (JP)

(21) Appl. No.: 14/225,169

(22) Filed: Mar. 25, 2014

(30) Foreign Application Priority Data
Mar. 25, 2013 (JP) 2013-062792

(51) Int. Cl. G09G 3/34

(52) U.S. Cl. CPC G09G 3/3406
USPC 345/102

(57) ABSTRACT

A control signal for controlling a light emitting element is generated according to a set value of an amount of light emission. In this event, each of a current value and a duty ratio of the control signal changes according to the set value of the amount of light emission. Further, it is preferable that each of the current value and the duty ratio changes according to the set value when the set value of the amount of light emission is less than a predetermined threshold value, and the current value changes according to the set value whereas the duty ratio is constant when the set value of the amount of light emission is greater than the predetermined threshold value.

### TECHNICAL FIELD

The invention relates to a control signal generating device that generates a control signal for controlling a light emitting element and an audio signal processing device including the control signal generating device.

### BACKGROUND ART

Conventionally, an amount of light emission from a light emitting element is controlled by controlling current to be applied to the light emitting element.

For example, PTL1 discloses that a dimming circuit of an electric-discharge lamp lighting device operates in a current dimming mode when applying a current beyond a predetermined current value to the electric-discharge lamp to light it, whereas it operates in a pulse dimming mode when applying a current of the predetermined current value or less to the electric-discharge lamp. The current dimming mode is a mode of dimming by changing current value of a current to be applied to a light emitting element, and the pulse dimming mode is a mode of dimming by changing duty ratio between an ON period and an OFF period of application of current.

PTL2 discloses that light amount control in a burst dimming mode (corresponding to the pulse dimming mode in PTL1) is performed based on output of a static dimming signal processing unit and light amount control in the current dimming mode is performed based on output of a dynamic luminance modulation unit.

### CITATION LIST

### Patent Literature

{PTL1 } JP 10-112396 A

{PTL2} JP 4686901 B2

### SUMMARY OF INVENTION

### Technical Problem

Incidentally, an audio signal processing device such as a digital mixer or the like is used in environments greatly different in brightness from a dark environment such as inside of a hall to a bright environment such as outdoors in daytime. It is therefore desirable that brightness of its display screen can be adjusted in a large dynamic range.

Further, in an especially dark environment, if the display screen is bright, its light may leak out to the surroundings to hinder staging or the like, whereas if the screen cannot be viewed, the operation is impossible. Therefore, to adjust the brightness in the dark environment, an adjustment function with high resolution is required which enables setting of the light amount at a plurality of levels in a region of an extremely small light amount.

Conversely, in a bright environment, appropriate brightness is greatly different between a cloudy day and a clear day even in the same outdoors. Therefore, an adjustment of brightness in a wide range is required rather than fine adjustment.

Considering employment of the configuration disclosed in PTL1 for the light amount adjustment thus required, it may be conceivable that the pulse dimming mode is employed in a region of a small light amount to control the light amount by duty ratio so as to suppress current as much as possible. Further, it may be also conceivable that the current dimming mode is employed in a region of a large light amount to greatly change current to be applied so as to control the light amount.

However, with this configuration, relation between change in set value and change in light amount greatly changes near the above-described predetermined current value where the dimming mode is switched between the pulse dimming mode and the current dimming mode. This brings about a problem of unnatural feeling of operation.

Further, if all adjustment of the light amount according to setting by a user is performed by the pulse dimming mode as in the configuration disclosed in PTL2, it is necessary to perform control of current value to be applied to the light emitting element with an extremely high resolution in a dark region. Accordingly, a controller with high resolution is necessary for setting of the light amount and setting of the current value associated therewith, bringing about a problem of increased cost.

Note that the same problem similarly occurs in the case of adjusting amount of light emission from a light emitting element which is conceivable to be used in a wide variety of environments also in other than the audio signal processing device.

The invention has been made in consideration of the above background, and it is an object to enable to perform light amount adjustment achieving both high resolution in a region of a small light amount and wide dynamic range as a whole at a low cost.

### Solution to Problem

To attain the above object, a control signal generating device of the invention includes a generator that generates a control signal for controlling a light emitting element according to a present value of one parameter specifying an amount of light emission of the light emitting element, wherein the control signal generated by the generator has a current value and a duty ratio each of which changes according to the present value of the parameter.

In such a control signal generating device, it is conceivable that each of the current value and the duty ratio of the control signal generated by the generator changes according to the present value of the parameter when the present value of the parameter is less than a predetermined threshold value, and the current value changes according to the present value of the parameter whereas the duty ratio is constant when the present value of the parameter is greater than the predetermined threshold value.

Further, it is also conceivable that the control signal generating device further includes: a controller; a voltage signal output device that outputs a direct current voltage signal with a voltage value set by the controller; and a pulse signal output device that outputs a pulse signal with a duty ratio set by the controller, wherein the generator generates, as the control signal, a signal for applying current with a current value according to the voltage value of the direct current voltage signal to the light emitting element at timing indicated by the pulse signal.

Further, an audio signal processing device of the invention includes the above control signal generating device, and a display, wherein the control signal generating device generates a control signal for controlling a backlight of the display.

### Advantageous Effects of Invention

A control signal generating device and an audio signal processing device of the invention as described above enables to perform light amount adjustment achieving both high resolution in a region of a small light amount and wide dynamic range as a whole at a low cost.

### BRIEF DESCRIPTION OF DRAWINGS

FIG. 1 is a diagram illustrating a structure of an illumination device that is an embodiment of a control signal generating device of the invention.

FIG. 2 is a graph illustrating relation between present value of a light amount parameter and effective current value of a drive signal outputted from an LED driver.

FIG. 3 is a graph illustrating the same relation as that in FIG. 2 by both logarithmic axes.

FIG. 4 is a graph for explaining resolution for setting light amount.

FIG. 5 is another graph of the same.

FIG. 6 is a diagram illustrating a structure of a digital mixer being an embodiment of an audio signal processing device incorporating a control signal generating device of the invention.

### DESCRIPTION OF EMBODIMENTS

Hereinafter, an embodiment for carrying out the invention will be concretely described on the basis of the drawings.

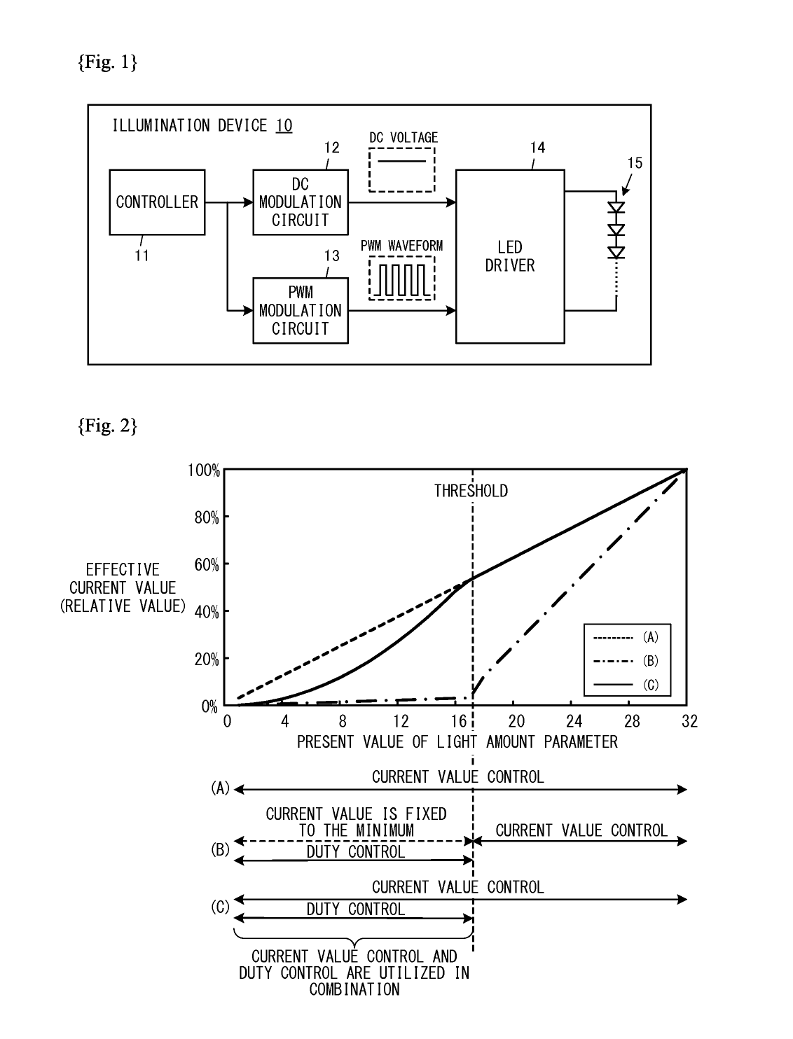

First, FIG. 1 illustrates a structure of an illumination device that is an embodiment of a control signal generating device of the invention.

The illumination device 10 includes a controller 11, a DC (direct current) modulation circuit 12, a PWM (pulse width modulation) modulation circuit 13, and an LED (light emitting diode) driver 14 which constitute a generator. The illumination device 10 utilizes the generator to generate a control signal (drive signal) for controlling lighting of the LED 15 that is a light emitting element. The LED driver 14 applies the control signal to the LED 15 to turn on the LED 15 and control light amount emitted from the LED 15.

The controller 11 has a function of accepting designation of amount of light emission from the LED 15 and storing the designated light amount as a value of one light amount parameter. The controller 11 acquires a voltage value to be set in the DC modulation circuit 12 and a duty ratio to be set in the PWM modulation circuit 13 based on a present value (a value set at present) of the light amount parameter, and sets those values. It is conceivable that the controller performs the acquisition of the voltage value and the duty ratio by searching a table preliminarily storing correspondence between the values to be acquired and the present value of the light amount parameter, or by some kind of arithmetic operation. Other methods may be used. The acceptance of the designation of the light amount may be performed by a physical control such as a knob, slider, rotary encoder or the like, or may be performed by a virtual control displayed on a screen such as a GUI (graphical user interface).

The DC modulation circuit 12 is a voltage signal output device that outputs a DC voltage signal with the voltage value set by the controller 11. Note that the voltage value can be set at, for example, a resolution of 5 bits. In this case, assuming that a set numerical value of 5 bits is X (0 to 31), the DC modulation circuit 12 can be configured to output a signal with a voltage value of [voltage maximum value]x(X+1)/32.

The PWM modulation circuit 13 is a pulse signal output device that outputs a PWM waveform signal with the duty ratio set by the controller 11. The PWM waveform is a rectangular wave at HIGH during a period indicated by the duty ratio among a whole period and at LOW during the remaining period. Any frequency may be used as long as it never generates flicker in display. The duty ratio can be set at, for example, a resolution of 5 bits. In this case, assuming that a set numerical value of 5 bits is Y (0 to 31), the PWM modulation circuit 13 can be configured to output a PWM waveform with a duty ratio of 100%×(Y+1)/32.

The LED driver 14 generates a drive signal that has a current value proportional to the voltage value of the DC voltage signal inputted from the DC modulation circuit 12 and becomes ON at the timing of HIGH of the PWM waveform inputted from the PWM modulation circuit 13. The LED driver 14 applies the drive signal to the LED 15. Accordingly, an effective current of the drive signal to be applied to the LED 15 is the current value×the duty ratio.

The LED 15 lights up with a light amount substantially proportional to the effective current value of the drive signal applied thereto by the LED driver 14. Accordingly, with a larger voltage value set in the DC modulation circuit 12 by the controller 11 and with a larger duty ratio set in the PWM modulation circuit 13 by the controller 11, the LED 15 lights up more brightly.

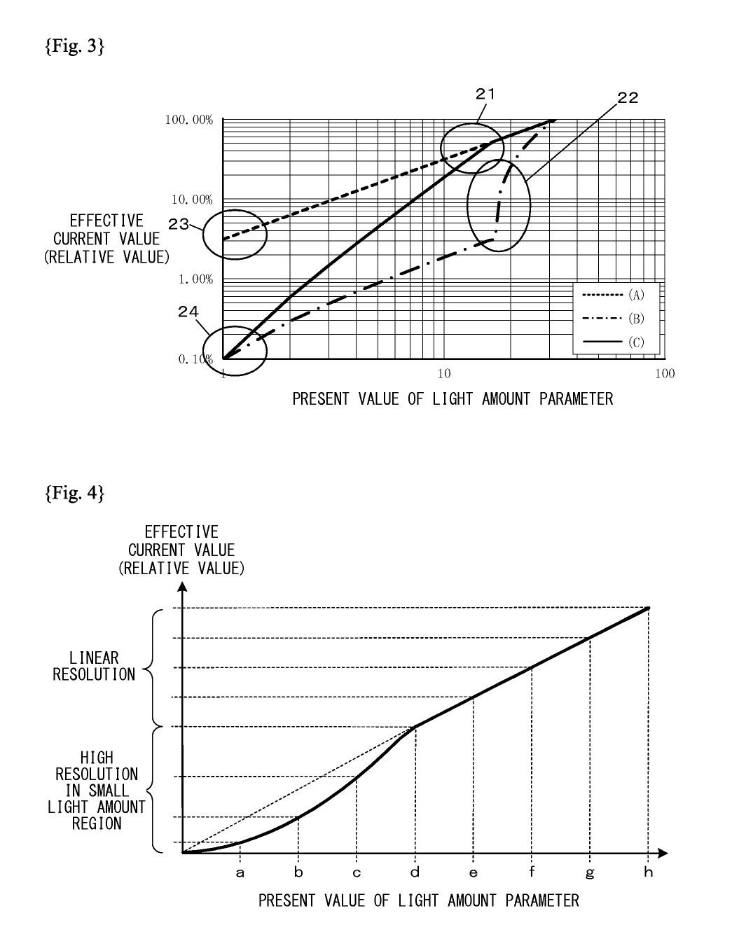

Next, the relation between present value of the light amount parameter and effective current value of the drive signal outputted from the LED driver 14 will be described using FIG. 2 and FIG. 3.

FIG. 2 and FIG. 3 are graphs illustrating relation between present value of the light amount parameter and effective current value of the drive signal outputted from the LED driver 14. Note that the effective current value is depicted in a form of ratio with respect to an outputtable maximum value. The values are depicted by a linear scale on both axes in FIG. 2 and are depicted by a logarithmic scale on both axes in FIG. 3, but the values plotted on the graphs are the same.

In examples in FIG. 2 and FIG. 3, it is assumed that value of the light amount parameter is set at 5 bits and range of values is set to 1 to 32 in consideration of convenience of indication on the logarithmic axes. Further, an example illustrated with (C) is an embodiment of the invention, and examples illustrated with (A) and (B) are comparative examples for explaining effects of the embodiment.

First, (A) is an example in the case of employing a current dimming mode (current value control) in the whole region of values of the light amount parameter.

In this case, assuming present value of the light amount parameter is N, and the voltage value X set in the DC modulation circuit 12 is X=N−1. Further, duty ratio Y set in the PWM modulation circuit 13 in the whole region of the values of the light amount parameter is 31 that is the maximum value. Accordingly, assuming the effective current value at a time when value of the light amount parameter is at the maximum is 100%, the effective current value corresponding to each value of the light amount parameter gradually decreases with a decrease in the value, and becomes 100×(1/32)≈3% when the present value N is 1. Refer to a portion indicted with a numeral 23 in FIG. 3.

It is found that a method using only the current dimming mode as in (A) cannot lower the lower limit of the light amount so much because of restriction of resolution in setting in the DC modulation circuit 12. Further, the effective current value corresponding to N=2 is 100×(2/32)≈6%. Consequently, it is impossible to perform fine adjustment on light amount in a region of a small light amount.

Next, (B) is an example in the case of employing a current dimming mode in a region where present value of the light amount parameter is equal to or greater than a threshold value and employing a pulse dimming mode (duty control) in a region where the present value is less than the threshold value.

Here, the threshold value is 17, and voltage value X set in the DC modulation circuit 12 is varied from substantially the maximum to the minimum in a region of value of the light amount parameter of 17 to 32. Hence, assuming present value of the light amount parameter is N, the voltage value X is X=2N−33. In this region, duty ratio Y set in the PWM modulation circuit 13 is 31 that is the maximum value. Further, in another region of value of the light amount parameter of 1 to 16, voltage value X is 0 and duty ratio Y set in the PWM modulation circuit 13 is varied from substantially the maximum to the minimum. Therefore, the duty ratio Y in this region is Y=2N−2.

Even in this mode, effective current value corresponding to each value of the light amount parameter gradually decreases with a decrease in the value, and becomes 100×(1/32)×(1/32)≈0.1% when the present value N is 1. Refer to a portion indicted with a numeral 24 in FIG. 3.

By separately utilizing the current dimming mode and the pulse dimming mode depending on range of present value of the light amount parameter as in (B), adjustable range of the light amount becomes wider than in the case of (A). Further, the effective current value corresponding to N=2 is 100×(1/32)×(3/32)≈0.3%, so that it is also possible to perform fine adjustment on light amount in a region of a small light amount.

However, since current adjustment in the current dimming mode needs to be performed at a smaller number of levels than that in (A), change in the effective current value according to change in value of the light amount parameter becomes rapid in this range. Further, at the point where the dimming mode is switched between the current dimming mode the pulse dimming mode, degree of the change in effective current value according to the change in value of the light amount parameter rapidly changes. For example, the effective current value (namely, amount of light emission of the LED 15) largely changes when value of the light amount parameter is changed by 1 in the range of the current dimming mode, whereas the effective current value rarely changes even when value of the light amount parameter is changed by 1 in the range of the pulse dimming mode. This generates unnatural feeling of operation when setting the light amount. Refer to a portion indicted with a numeral 22 in FIG. 3.

Further, the minimum voltage (current) is used as a voltage value (current value of the drive signal by the LED driver 14) of the DC modulation circuit 12 in a wide range of vales of the light amount parameter. The amount of light emission of the LED 15, however, largely varies among individuals in a state of a small current value due to manufacturing error, and thus has difficulty in stable light emission. In this regard, even in the mode of (B), it cannot be said that fine light amount adjustment in a region of a small light amount can be appropriately performed.

Next, (C) is an example in the case of employing the current dimming mode in a region where present value of the light amount parameter is equal to or greater than a threshold value and employing both the current dimming mode and the pulse dimming mode in combination in a region where the present value is less than the threshold value.

In the example of (C), current control by the current dimming mode as in (A) is performed in the whole region of values of the light amount parameter, while the pulse dimming mode is also utilized in a region of value of the light amount parameter of 1 and 16. In other words, duty ratio Y set in the PWM modulation circuit 13 is varied from substantially the maximum to the minimum in this range. Therefore, the duty ratio Y in this range is Y=2N−2 as in the example of (B).

By using both the current dimming mode and the pulse dimming mode in combination as in (C), the dynamic range of the light amount adjustment is widened as in the case of (B). Refer to the portion indicted with the numeral 24 in FIG. 3. Further, the effective current value corresponding to N=2 is 100×(2/32)×(3/32)≈0.6%, so that it is also possible to sufficiently secure resolution for the light amount adjustment in a region of a small light amount.

Furthermore, variation in the voltage value of the DC modulation circuit 12 is made uniform in the whole range of values of the light amount parameter, while duty ratio set in the PWM modulation circuit 13 is varied additionally in a partial range. Accordingly, degree of change in the effective current value according to change in value of the light amount parameter never rapidly changes. This eliminates unnatural feeling of operation when setting the light amount. Refer to a portion indicted with a numeral 21 in FIG. 3.

Moreover, current value of the drive signal to the LED 15 basically takes a value higher than the minimum value also in a region of a small light amount, thus enabling light emission with a stable light amount. In other words, there is less influence caused by characteristic variations among individuals of the LED 15.

As described above, utilizing both the current dimming mode and the pulse dimming mode in combination as in (C) makes it possible to appropriately perform the light amount adjustment while achieving both high resolution in a region of a small light amount and wide dynamic range as a whole.

Incidentally, to achieve a dynamic range of about 1000 times (corresponding to 10 bits), it is only necessary to configure the controller 11, the DC modulation circuit 12, and the PWM modulation circuit 13 such that each of them can handle data of 5 bits. Generally, cost of a circuit is higher as number of bits to be handled is larger. Accordingly, it can be said that according to the mode of (C), a wide dynamic range can be realized using inexpensive circuits.

Further, there is less influence caused by characteristic variations among individuals of the LED 15 and, in other words, even if degree of elimination of characteristic variations is slightly low at manufacture of the illumination device 10, emission unevenness in the illumination device 10 is inconspicuous. Consequently, in this regard, the calibration burden at manufacture of the illumination device 10 can be reduced to reduce costs.

Note that the reason why the pulse dimming mode is not used in combination in the case of a large light amount in the mode of (C) is to prevent noise. There is a great influence of noise when ON/OFF of a signal with a large current value is switched, but a duty ratio of 100% never causes switching of ON/OFF and can thereby prevent occurrence of noise even with a larger current value of the drive signal.

Here, relation between present value of the light amount parameter and effective current value of the LED drive signal in the mode of (C) will be further described using FIG. 4.

In FIG. 4, a to h indicate values being 1/8 to 8/8 of the maximum value of the light amount parameter, respectively.

In the example (C) in FIG. 2, in the case where the present value of the light amount parameter is larger than a value (d) that is a half of the maximum value, only the current dimming mode is used. In this case, change in the effective current value (and amount of light emission of the LED 15) becomes linear with respect to change in value of the light amount parameter. On the other hand, in the case where the present value is smaller than the value that is a half of the maximum value, both the current dimming mode and the pulse dimming mode are utilized in combination. In this case, change in the effective current value with respect to change in value of the light amount parameter is small in a region of a small light amount and large in a region of a large light amount. Therefore, it is possible to perform the light amount adjustment with high resolution in the region of a small light amount. This is because both current value and duty ratio of the drive signal are increased according to increase in value of the light amount parameter, and the effective current value thereby becomes a quadratic function of the value of the light amount parameter.

Note that in the case where the present value is within a range of c to d, the resolution is lower than the case where the present value is d or more. However, since demand to set intermediate light amount around those values is considered not to be so high, there is no problem even if the resolution is slightly degraded. Conversely, it is preferable to determine a range where both the current dimming mode and the pulse dimming mode are used in combination, voltage value settable in the DC modulation circuit 12, and value of the duty ratio settable in the PWM modulation circuit 13 so that a region with low resolution falls within a light amount range with not much demand.

Note that though the examples where value of the light amount parameter in the controller 11, set value of the voltage in the DC modulation circuit 12, and set value of the duty ratio in the PWM modulation circuit 13 are respectively 5 bits has been described here, those values are not limited to 5 bits. Those values may be 8 bits.

This enables light amount adjustment with a dynamic range of 16 bits using set value of 8 bits regarding the light amount. However, it is desirable to keep the dynamic range at about 13 bits because if the whole dynamic ranges of the voltage value and the duty ratio are used, current value of the drive signal becomes too low and ON period becomes too short to result in a possibility that the LED cannot normally light up.

Incidentally, even if value of the light amount parameter takes any bits, the relation illustrated in FIG. 4 is maintained as long as relation is linear between present value of the light amount parameter, voltage value set in the DC modulation circuit 12 and duty ratio set in the PWM modulation circuit 13 in a range where the pulse dimming mode is utilized in combination.

However, it is not essential. For example, in the case where voltage value of the DC modulation circuit 12 and duty ratio of the PWM modulation circuit 13 can be set to be finer than value of the light amount parameter, it is also conceivable to set the values such that, as the set values are smaller, variation widths in the voltage value and/or the duty ratio per value of the light amount parameter of 1 are smaller in the range where the pulse dimming mode is utilized in combination.

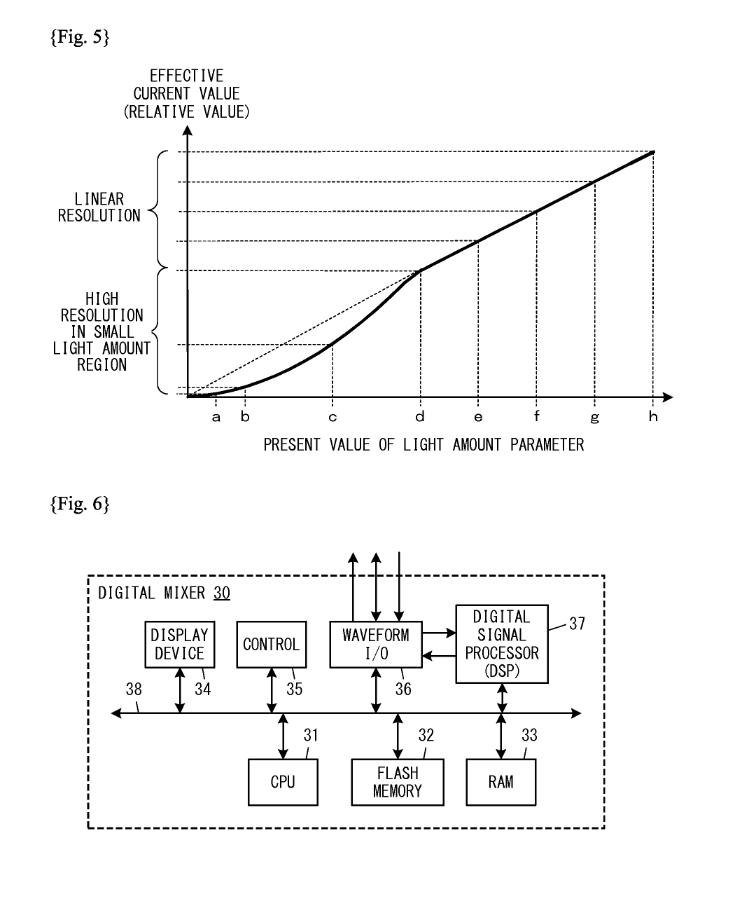

This makes it possible to further improve, as illustrated in FIG. 5, resolution for setting the light amount in a region of a small light amount (for example, a range of present value of the light amount parameter of b or less) than in the case of FIG. 4. Such a configuration is useful when precise adjustment in a region of a small light amount is important. Note that though the resolution is lower in the example of FIG. 5 than in the example of FIG. 4 in a range of b to d, there is not any particular problem as long as light amount with not much setting demand falls within this range.

It is conceivable that the illumination device 10 as has been described is used as a backlight for a display device such as a liquid crystal panel or the like in an audio signal processing device such as a digital mixer or the like. In this case, it is preferable that the LED 15 is used as the backlight, and the controller 11 to the LED driver 14 are used as the control signal generating device that generates a control signal for controlling the lighting of the LED 15.

FIG. 6 illustrates an example of a hardware structure of a digital mixer incorporating the illumination device 10.

In the digital mixer 30, a CPU 31 is a controller that centrally controls operation of the digital mixer 30, and implements various control functions by executing a necessary control program stored in a flash memory 32. The CPU 31 may also serve as the controller 11.

The flash memory 32 is a rewritable, non-volatile memory that stores data to be left even after the power is turned off, including the control program executed by the CPU 31.

A RAM 33 is a memory that stores data to be temporarily stored and is used as a work memory for the CPU 31.

A display device 34 is a display that displays various kinds of information according to control by the CPU 31, and includes a display panel with the LED 15 as a backlight.

A control 35 is for accepting an operation on the digital mixer 30, and can be composed of various objects such as keys, buttons, rotary encoders, knobs, sliders and so on.

A waveform input/output unit (waveform I/O) 36 is an interface for inputting/outputting audio signals from/to the outside of the digital mixer 30.

A digital signal processor (DSP) 37 is an audio signal processor that performs various kinds of processing including mixing, equalizing and effect application, on the audio signals inputted from the waveform I/O 36, and supplies processing results to the waveform I/O 36 so as to output the results to the outside.

A system bus 38 connects the above devices and units.

The digital mixer 30 as described above is used in environments greatly different in brightness, and there is a great need for adjustment on brightness of the display device 34 with high resolution in a dark environment. Accordingly, it is especially useful to apply the illumination device 10 so as to enable the light amount adjustment achieving both high resolution in a region of a small light amount and wide dynamic range.

Though the description of the embodiment ends here, the invention is not limited to those described in the above embodiment as a matter of course.

For example, both the current dimming mode and the pulse dimming mode are utilized in combination in the case where value of the parameter specifying the amount of light emission of the LED 15 is generally equal to or less than half of the maximum value in the above embodiment. However, the invention is not limited to this case. Both the current dimming mode and the pulse dimming mode may be utilized in combination in a wider range or a narrower range. The range where only the current dimming mode is utilized may not be provided, and both the current dimming mode and the pulse dimming mode may be utilized in combination in the whole range of values of the parameter.

The example where voltage value of the DC modulation circuit 12 is set according to value of the parameter specifying an amount of light emission of the LED 15 to thereby indirectly set current value of the drive signal outputted from the LED driver 14 has been described in the above-described embodiment. However, current value of the drive signal may be directly set according to value of the above parameter.

The case of using the LED as the light emitting element has been described in the above-described embodiment. However, the invention is applicable also to cases of controlling other light emitting elements. For example, the invention is applicable also to a device controlling amount of light emission of other light emitting elements such as a cathode tube, LD (laser diode), organic EL (electroluminescence), plasma, discharge tube, semiconductor laser and the like.

Further, device that can incorporate the control signal generating device in the above-described embodiment is not limited to the audio signal processing device. The control signal generating device can be incorporated in any device provided with a light emitting element, including a display panel constituting a motorcycle gauge.

The constructions and modification examples which have been described above can be combined appropriately and applied while it is consistent.

### INDUSTRIAL APPLICABILITY

As is apparent from the above description, according to the invention, it is possible to perform light amount adjustment achieving both high resolution in a region of a small light amount and wide dynamic range as a whole at a low cost.

Accordingly, applying the invention makes it possible to improve convenience in adjustment of light amount of light emitting elements.

### REFERENCE SIGNS LIST

11 . . . controller, 12 . . . DC modulation circuit, 13 . . . PWM modulation circuit, 14 . . . LED driver, 15 . . . LED, 30 . . . digital mixer, 31 . . . CPU, 32 . . . flash memory, 33 . . . RAM, 34 . . . display, 35 . . . control, 36 . . . waveform I/O, 37 . . . DSP

1. A control signal generating device, comprising
a generator that generates a control signal for controlling a light emitting element according to a present value of one parameter specifying an amount of light emission of the light emitting element,
wherein the control signal generated by the generator has a current value and a duty ratio each of which changes according to the present value of the parameter.

2. The control signal generating device according to claim 1,
wherein each of the current value and the duty ratio of the control signal generated by the generator changes according to the present value of the parameter when the present value of the parameter is less than a predetermined threshold value, and the current value changes according to the present value of the parameter whereas the duty ratio is constant when the present value of the parameter is greater than the predetermined threshold value.

3. The control signal generating device according to claim 1, further comprising:
a controller;
a voltage signal output device that outputs a direct current voltage signal with a voltage value set by the controller; and
a pulse signal output device that outputs a pulse signal with a duty ratio set by the controller,
wherein the generator generates, as the control signal, a signal for applying current with a current value according to the voltage value of the direct current voltage signal to the light emitting element at timing indicated by the pulse signal.

4. An audio signal processing device comprising the control signal generating device according to claim 1, and a display,
wherein the control signal generating device generates a control signal for controlling a backlight of the display.
